(19) United States
(12) Patent Application Publication
(10) Pub. No.: US 2016/0037245 A1
(43) Pub. Date: Feb. 4, 2016

(54) Discrete MEMS Including Sensor Device

(71) Applicant: Knowles Electronics, LLC, Itasca, IL (US)

(72) Inventor: Brandon Harrington, Chicago, IL (US)

(21) Appl. No.: 14/792,821

(22) Filed: Jul. 7, 2015

Related U.S. Application Data
(60) Provisional application No. 62/030,305, filed on Jul. 29, 2014.

(51) Int. Cl. H04R 1/08

(52) U.S. Cl. CPC H04R 1/08; H04R 2201/003

(57) ABSTRACT

A micro electro mechanical system (MEMS) microphone includes a base; a MEMS device disposed on the base, the MEMS device comprising a diaphragm and a back plate; a condition sensor disposed on the base; and an integrated circuit coupled to the condition sensor and the MEMS device. The MEMS device operates to detect acoustic signals in a first frequency range and the condition sensor acts as a condition sensor in the first frequency range. The condition sensor acts as a microphone in a second frequency range and the MEMS device is unused so as to extend the operating range and acoustic overload point of the MEMS device.

### CROSS REFERENCE TO RELATED APPLICATIONS

This patent claims benefit under 35 U.S.C. §119 (e) to U.S. Provisional Application No. 62030305 entitled “Discrete MEMS including sensor device” filed Jul. 29, 2014, the content of which is incorporated herein by reference in its entirety.

### TECHNICAL FIELD

This application relates to microelectromechanical system (MEMS) devices and, more, specifically, to MEMS microphones.

### BACKGROUND OF THE INVENTION

Various types of microphones and receivers have been used through the years. In these devices, different electrical components are housed together within a housing or assembly. Other types of acoustic devices may include other types of components. These devices may be used in hearing instruments such as hearing aids, personal audio headsets, or in other electronic devices such as cellular phones and computers.

As mentioned, one example of a MEMS device is a MEMS microphone. The MEMS microphone receives an acoustic signal and converts the acoustic signal into an electrical signal.

MEMS microphones typically operate in restricted frequency ranges. At some point, there is an acoustic overload point above which signals will be distorted, or operate properly. In other words, the acoustic overload point is when the microphone becomes distorted significantly from the incoming acoustic signal. This acoustic overload point is sometimes a relatively low value.

Because the value of the cutoff frequency is a relatively low value, there are frequencies of interest that are simply not processed or recognized and this has limited the operating range of previous microphones. The above-mentioned problems have created some user dissatisfaction with these previous systems.

### BRIEF DESCRIPTION OF THE DRAWINGS

For a more complete understanding of the disclosure, reference should be made to the following detailed description and accompanying drawings wherein:

FIG. 1 comprises a block diagram of a microphone or system that uses a MEMS device and a sensor according to various embodiments of the present invention;

FIG. 2 comprises a diagram of one example of the operation of a microphone or system that uses a MEMS device and a sensor according to various embodiments of the present invention;

FIG. 3 comprises a graph showing aspects of one example of the operation of a microphone or system that uses a MEMS device and a sensor according to various embodiments of the present invention;

FIG. 4 comprises another graph showing aspects of one example of the operation of a microphone or system that uses a MEMS device and a sensor according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated.

Approaches are provided that allow the use of a MEMS device and a sensing device (e.g., a pressure sensor or a temperature sensor to mention two examples) to extend the operating ranged of an acoustic device. In one aspect, low frequency signals are sensed in a microphone by using a MEMS device (e.g., where the MEMS device includes a MEMS die, a diaphragm, back plate structure where the diaphragm moves in the presence of changing sound pressure to create an electrical signal). High frequency signals are detected using the sensing device. In one aspect, the sensing device is not used to sense sound energy in the low frequency operating range.

In another aspect, a smaller discrete die is used in a top port configuration with a small back volume (e.g., 250 micrometers die height) in parallel with a primary microphone die that is disposed over the port. In this example, the MEMS device and the sensor are disposed on a substrate, but the port extends through the lid.

In other aspects, a MEMS-on-lid configuration is used. In this configuration, the MEMS device is attached to the lid and a port extends through the lid. In this configuration the lateral dimensions are smaller since the MEMs-on-lid can be overlapped with another compound. The lid die will have a lower acoustic sensitivity to the constrained back volume. Both dies will route their signals to a common integrated circuit (e.g., ASIC).

In another example, a bottom port configuration (wherein the port hole extends through the base or substrate) is used. A second die such as a pressure sensor or accelerometer. The second die does not have a primary sense mechanism of acoustic pressure. However, the low cross sensitivity of the second die is used to extract the acoustic signal at higher acoustic pressures. For example, in the case of a pressure sensor the die is intrinsically sensitive to extremely low frequency pressure changes and not sensitive to signals in the acoustic regime. However, since the input signal is large enough so that the pressure sensor will output some attempted acoustic signal.

In many of these embodiments, a micro electro mechanical system (MEMS) microphone includes a base, a MEMS device disposed on the base, and the MEMS device includes a diaphragm and a back plate. A condition sensor is disposed on the base. An integrated circuit coupled to the condition sensor and the MEMS device. The MEMS device operates to detect acoustic signals in a first frequency range and the condition sensor acts as a condition sensor in the first frequency range. The condition sensor acts as a microphone in a second frequency range and the MEMS device is unused so as to extend the operating range and the acoustic overload point of the MEMS device.

In some aspects, the condition sensor is a pressure sensor, a temperature sensor, or an accelerometer. Other examples are possible.

The microphone may be a top port device, a bottom port device, or a MEMS on lid device. In some examples, the integrated circuit is application specific integrated circuit (ASIC). In some aspects, the integrated circuit includes a low pass filter. In some other examples, the integrated circuit includes a band pass filter.

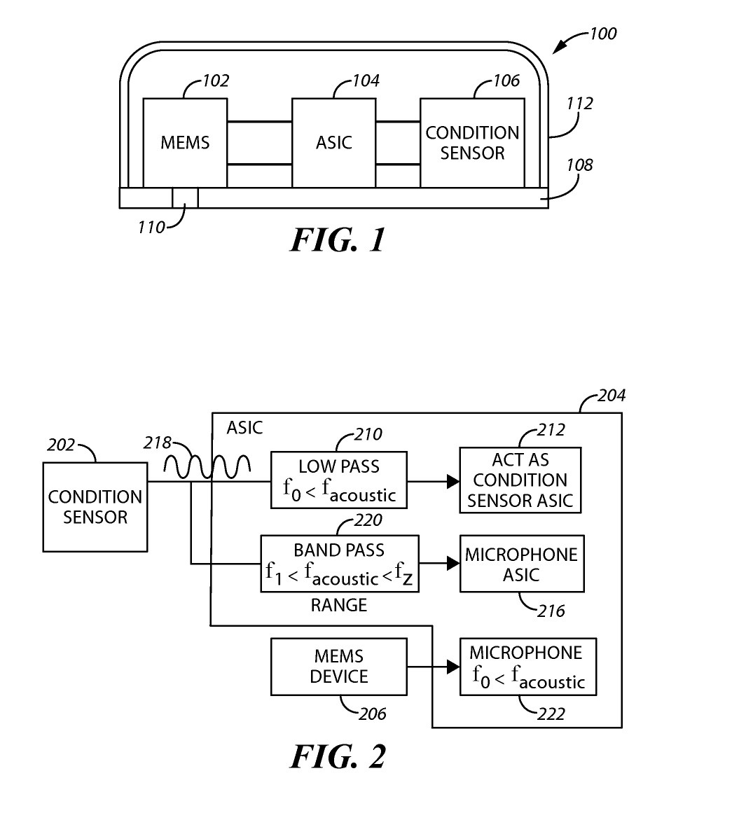

Referring now to FIG. 1, one example of a microphone or system 100 that senses acoustic signals across a wide operating range is described. In the approaches described herein, the acoustic overload point is extended. In one aspect, this is accomplished using a condition sensor, which has low acoustic sensitivity to chop out the audio frequencies and pass signals with these frequencies to the microphone ASIC.

The microphone or system 100 is a bottom port example and includes a microelectromechanical system (MEMS) device 102, an application specific integrated circuit (ASIC) 104, and a condition sensor 106. In other examples, a top port configuration is used where the port is on the lid and the components are disposed on the substrate or base can be used. In still other examples, a MEMS-on-lid configuration is used where the port is on the lid and the MEMS component is on the lid covering the port. In this type of configuration, some or all of the other components are disposed on the substrate or base can be used while some of the components may be disposed on the lid.

The MEMS device 102, ASIC 104, and condition sensor 106 are disposed on a substrate 108. The substrate 108 has a port or opening 110 extending through the substrate 108. The substrate 108 may be, for example, a printed circuit board. Other examples of substrates are possible.

A cover 112 is attached to the substrate 108. Sound pressure enters though the port 110. The MEMS device 102 includes a MEMS die, a diaphragm, and a back plate. The sound pressure moves the diaphragm and the resultant movement creates an electrical signal that can be processed by the ASIC 104.

The condition sensor 106 may be any type of sensor that senses conditions. For example, the condition sensor 106 may be a pressure sensor, a temperature sensor, or an accelerometer. Other examples of sensors are possible.

As will be explained in greater detail elsewhere herein, the MEMS device 102 operates to detect acoustic signals in certain ranges, while the condition sensor 104 detects signals in other ranges. It will be appreciated that since the condition sensor 104 is used to capture higher acoustic pressures, then the operation of the MEMS microphone is extended.

Referring now to FIG. 2, a block diagram that illustrates the operation of the present approaches is described. A MEMS device 206 and a condition sensor 202 is coupled to an ASIC 204. The ASIC 204 may include a low pass filter 210 and a band pass filter 220.

The condition sensor 202 may be a temperature sensor, pressure sensor, accelerometer, or some other sensing device that measures or senses a condition and then creates a signal that is a measurement of the condition. For example, the condition sensor 202 (if it were a pressure sensor) outputs a signal 218 that is representative of sensed pressure. The signal 218 arrives at the ASIC 204.

A low pass filter 210 at the ASIC 204 operates on the signal 218 such that low frequency signals. The low pass filter 210 filters out low frequency signals from the condition sensor 202 so that the condition sensor 202 is configured to act as a condition sensor in this low frequency ranges below that of the acoustic range.

The signal 218 also arrives at a band pass filter 220. If the signal has a frequency that is between f₁ and f₂, the signal is passed and condition sensor 202 operates as a microphone at step 214. In this situation, the signal 218 is assumed to be an acoustic signal that the ASIC 204 processes as an acoustic signal at step 216. Thus, it will be appreciated that signals having higher than predetermined frequencies (between f₁ and f₂) are obtained by the condition sensor can be processed by the system.

The MEMS device 206 also obtains the acoustic signal and acts as a microphone at step 208 whenever f₀<f_{acoustic} where f₀ is the frequency of the signal obtained by the MEMS device 206 and f_{acoustic} is the upper limit of the MEMS device 206. At step 222, the ASIC 204 processes the signal while the MEMS device 206 is acting as a microphone.

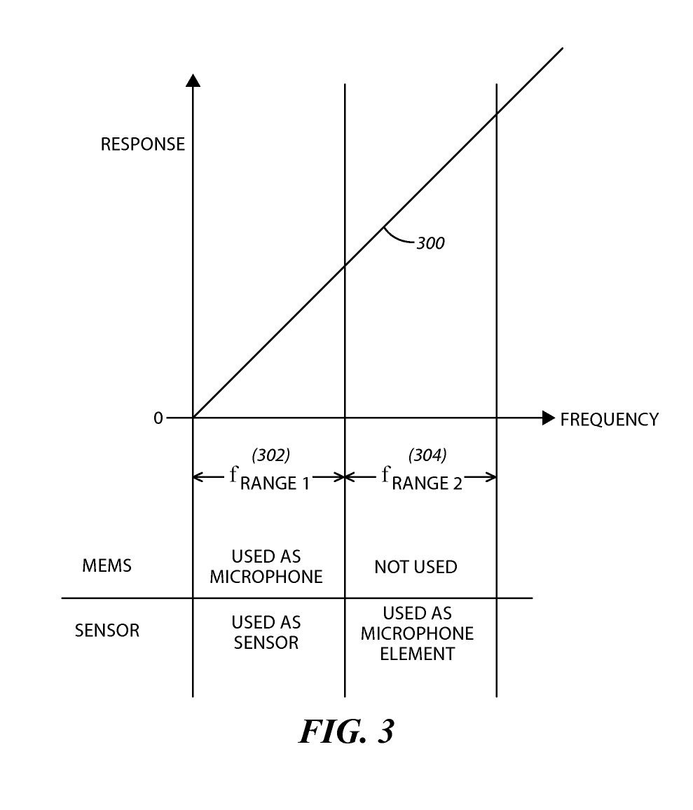

Referring now to FIG. 3, one example of the operating ranges of the acoustic devices described herein is described. A response curve 300 is shown that plots response (on the x-axis) versus frequency (on the y-axis).

As can be seen, in a first frequency range 302, the MEMS device is used as a microphone while the sensor is used as a sensor.

In a second frequency range 304, the MEMS device is not used—the frequencies are too high. However, the sensor is used as a microphone element. Thus, in this mode the sensor signal is treated as an acoustic signal by the ASIC and sound or acoustic information is obtained from the signal that is received from the condition sensor. In this way and with the use of the additional condition sensor, the frequency operating range of a microphone can be extended.

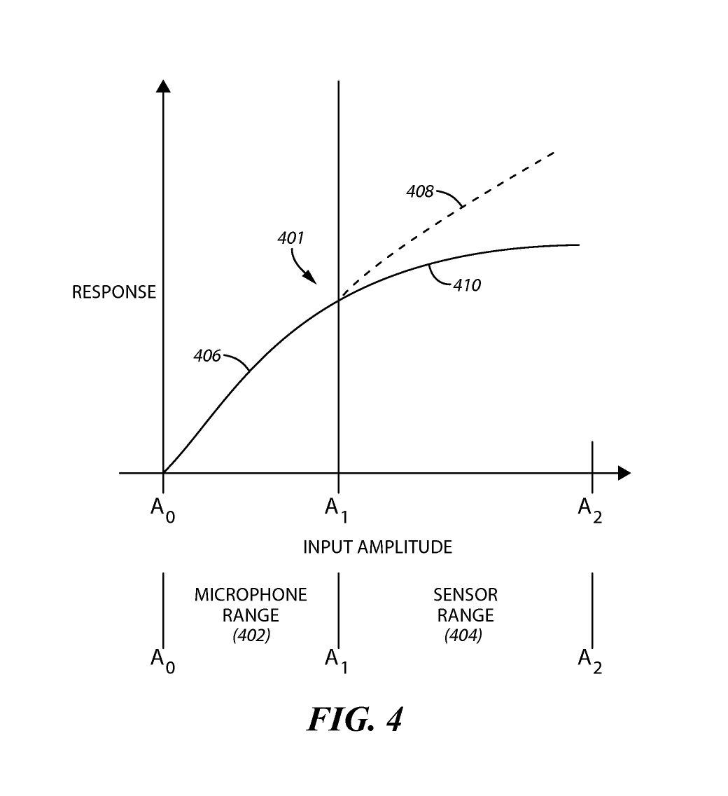

Referring now to FIG. 4, an example of a graph showing the operation of the approaches described herein is described. Curves, generally indicated by the arrow having the label 401 show the relationship between the input amplitude of a signal (associated with the x-axis) and the response of the microphone system (associated with the y-axis),

As can be seen in the graph of FIG. 4, in a first region 406 (between amplitude values A0 and A1) of the curves 401, the response is linear. The microphone operates in this microphone operational range 402.

As the input amplitude increases above A1 and until it reaches amplitude A2, the apparatus operates in a sensor operational range 404. In this range 404, the response is indicated by the linear response that has been labeled 408. It will be appreciated that without the sensor operation in this range (i.e., simply using the microphone to obtain acoustic signals in this range), the response of the system would have been a non-linear curve that is labeled 410. As will be appreciated, it is desirable that the response be linear to avoid problems, for example, problems associated with distortion. Consequently, the sensor provides for linear response at higher input amplitudes therefore dramatically increasing the operational range of previous systems and devices.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A micro electro mechanical system (MEMS) microphone, comprising:
a base;
a MEMS device disposed on the base, the MEMS device comprising a diaphragm and a back plate;
a condition sensor disposed on the base;
an integrated circuit coupled to the condition sensor and the MEMS device;
wherein the MEMS device operates to detect acoustic signals in a first frequency range and the condition sensor acts as a condition sensor in the first frequency range;
wherein the condition sensor acts as a microphone in a second frequency range and the MEMS device is unused so as to extend the operating range and the acoustic overload point of the MEMS device.

2. The MEMS microphone of claim 1, wherein the condition sensor is a pressure sensor, a temperature sensor, or an accelerometer.

3. The MEMS microphone of claim 1, wherein the microphone is a top port device.

4. The MEMS microphone of claim 1, wherein the microphone is a bottom port device.

5. The MEMS microphone of claim 1, wherein the microphone is a MEMS on lid device.

6. The MEMS microphone of claim 1, wherein the integrated circuit is application specific integrated circuit (ASIC).

7. The MEMS microphone of claim 1, wherein the integrated circuit includes a low pass filter.

8. The MEMS microphone of claim 1, wherein the integrated circuit includes a band pass filter.
